(19) United States
(12) Patent Application Publication
(10) Pub. No.: US 2006/0046595 A1
(43) Pub. Date: Mar. 2, 2006

(54) Re-sticking preventive laminate

(76) Inventors: Sayuri Imaizumi, Kawagoe-shi (JP); Isao Katou, Nihonbashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/214,032

(22) Filed: Aug. 30, 2005

(30) Foreign Application Priority Data
Aug. 31, 2004 (JP) 2004-253223
Jun. 30, 2005 (JP) 2005-192212

(51) Int. Cl. B32B 27/04; B32B 27/12; B32B 7/12

(52) U.S. Cl. 442/151; 442/149; 428/343

(57) ABSTRACT

A new Re-sticking preventive laminate is provided, which has numbers of pores in the cohesive failure layer and has suitable peeling strength.

In the Re-sticking preventive laminate of the present invention, cohesive failure layer 2 is provided on at least one side of the substrate 1 by means of coating, and adhesive layer 3 is provided on the surface of the cohesive failure layer 2, and, the cohesive failure layer 2 has a porous structure provided by wet solidification process.

### FIELD OF THE PRESENT INVENTION

The present invention relates to laminates that can be using for anti-forgery labels, seals or sheets, in particular, to a Re-sticking preventive laminates that can not be simply re-sticked.

### BACKGROUND ART

So far, kinds of Re-sticking preventing labels, seals or sheets have been reported. For instance, JP-A-08030202 (Document D1) disclosed a Re-sticking preventing label, which comprises a surface substrate, a cohesive failure layer which is formed on the rear face of the substrate and which carries out cohesive failure at the time of the peeling of substrate, adhesive layer formed on the rear face of the cohesive failure layer. In addition, JP-A-2003-171478 (Document D2) disclosed a brittle adhesive sheet using resin composition which containing polyurethane resins and inorganic fillers.

However, in the Re-sticking preventing label disclose in D1, in order to get the desired value of peeling strength, it is necessary to increase the amount of the filler in the cohesive failure layer which are only consisting of fillers and resins, hence gives rise to the troublesome of forming paper powder on the surface of the cohesive failure layer. In addition, the cohesive failure layer is solidified tightly by the solid components, so as to result in a large raw material consumption and subsequent high cost.

Moreover, for the reason that the brittle adhesive sheets disclosed in D2 use polyurethane resins as raw materials, there exists the shortcoming of bad weathering qualities in different applications.

### DETAILED DESCRIPTION OF THE PRESENT INVENTION

[Problem to be Solved by the Present Invention]

An objective of the present invention is to provide a new Re-sticking preventive laminate, which has numbers of pores in the cohesive failure layer and suitable peeling strength.

[Means for Solving the Problem]

The constitute of the present invention for the fulfillment of the above object is a Re-sticking preventive laminate, wherein an cohesive failure layer is provided by coating in at least one side of the substrate, and an adhesive layer is provided on the surface of the cohesive failure layer, characterized in that the cohesive failure layer has an porous structure provided by wet solidification process.

In the above-mentioned constitute of the present invention, a density of 0.5˜1.0 g/cm³ according to JIS P8118 is desirable. Moreover, the arithmetic average roughness Ra of the peeling surface on the adhesive layer side of the cohesive failure layer which is destroyed by peeling is preferred in the range of 0.4˜1.0 μm. Furthermore, preferred cohesive failure layer contains resins and fillers. It is possible to adjust the numbers and sizes of pores in the cohesive failure layer by adjusting the weight concentration of the solid components forming the layer and/or the weight ratios between the fillers and resins in the solid components in the coating fluid. The weight concentration of the solid components of the coating fluid which forms the cohesive failure layer is preferably in the range of 5˜60 wt %. Moreover, it is desirable to adjust the weight ratios between the fillers and resins in the solid components in the coating fluid which forms the cohesive failure layer in the range of 0.5˜6.0 based on resin 1.

Moreover, in the above-mentioned constitute of the present invention, when a processing with partly changed peeling strength is carried out on any side of the above cohesive failure layer, and the above-mentioned cohesive failure layer is cohesive destroyed, it is able to display the above processed parts or un-processed parts with character, signal or number and the like forms. Processes may comprise the processes increasing or decreasing the adhesive strength between the cohesive failure layer and the layer contact with it, the processes injecting ink into the pores of the cohesive failure layer by printing or the like, the solvent coating processes dissolving the resin of the cohesive failure by coating solvents, the pressing processes changing the thickness of the cohesive failure layer by extruding or hot-pressing, and so on.

[Effect of the Present Invention]

The Re-sticking preventive laminate of the present invention can be used for Re-sticking preventive labels, seals or sheets, because cohesive failure occurs when the laminate is peeled, it is not able to stick again even if it is desired. Moreover, because of the porous structure of the cohesive failure layer, substantial cohesive failure is resulted, and it is difficult to recover.

Furthermore, it is able to adjust peeling strength according to different application, by changing the weight concentration of the solid components in the coating fluid forming the cohesive failure layer or the weight ratios between the solid fillers and solid resins in the cohesive failure layer.

### PREFERRED EMBODIMENTS OF THE PRESENT INVENTION

Next, detailed description of the embodiments of the present invention will be given with the reference of the figures.

FIG. 1 shows the cross-section view of one embodiment of the Re-sticking laminate of the present invention suitable for labels.

FIG. 2 is the enlarged plane figure of the peeling surface on the adhesive layer side after the label of FIG. 1 was peeled.

FIG. 3 shows the cross-section view of another embodiment of the Re-sticking laminate of the present invention suitable for labels.

FIG. 4 shows the cross-section view showing the procedure of peeling the label of FIG. 3.

FIG. 5 shows the plane view on the adhesive layer side displaying with characters when the label of FIG. 3 was peeled.

And in FIG. 1, 1 represents substrate, 2 represents the cohesive failure layer provided on one side of substrate 1, 3 represents adhesive layer provided on the surface of the cohesive failure layer 2. Moreover, it can also laminate different layers with various functions on the surface opposite to the surface on which the cohesive failure layer 2 of substrate 1 is provided. For instance, it is able to enhance the printing flexibility by means of providing ink-accepting layer. And, it is allowed to provide coating layer (not showed in the figure) between the cohesive failure layer 2 and adhesive layer 3, and it is also allowed to provide cohesive failure layer 2 on both sides of substrate 1.

The substrate 1 of the present invention can substantially use any as long as it is a film-like or sheet-like and can be coated. The thickness of substrate 1 is in the range of 10˜400 μm, and preferably in the range of 20˜300 μm. The film-like substrate includes, for example, plastic film. Plastic film includes, for example, films of polyethylene terephthalate, polypropylene or their foams; or films contains pigments such as calcium carbonate, titanium oxide, barium sulphate etc.; films of polystyrene, polyvinyl chloride, polymethyl methacrylate, polyethylene, polycarbonate, polyester and so on. And from the point of suitable stiffness (rigidity) of the label, films of polyester, polypropylene are preferred. Moreover, in order to increase the adhesiveness between the surface of substrate 1 and cohesive failure layer 2, it is possible to provide adhesion facilitation processing layer, or, carry out a corona discharge processing. Furthermore, in order to increase the adhesive strength between the substrate 1 and cohesive failure layer 2, it is possible to provide an anchor coat layer, or, to provide a middle layer in order to increase the cushioning characteristic.

The cohesive failure layer 2 is provided by coating on at least one side of the substrate 1 with coating fluid containing resins and fillers. The coating methods can use wet solidification process. Here, the wet solidification process indicate the process includes: prepare the coating fluid by adding fillers into the solution prepared by dissolving resin in organic solvents, coat the coating fluid on the substrate, after that, through the liquid which are compatible with the above-mentioned organic solvent but can not dissolve the above-mentioned resin to substitute the organic solvent, then solidify, dry, thus form the cohesive failure layer as coating layer.

The formed cohesive failure layer (coating layer) is formed into porous structure. The mechanism of this is that when the solidification is carried out by through the liquid which are no-solvent for resin, the diffusion passages form into caves as the organic solvent diffuse into the liquid, and the caves turns into pores. The times of through the liquid generally are 2. The temperature of the liquid is in the range of 15° C.˜40° C., and preferably in the range of 20° C.˜30° C. in the first run; and in the range of 60° C. or more and lower than 100° C., and preferably in the range of 80° C.˜95° C. in the second run. By adjusting the temperature into the above range, it is able to adjust the numbers and sizes of pores, and it is able to enlarge the pores by increase the temperature.

The numbers or diameters of the pores in the cohesive failure layer 2 can be adjusted by changing the weight concentration of the solid components of the coating fluid which forms the cohesive failure layer, or changing the ratios of the weight of filler solid components/the weight of resin solid components in the cohesive failure layer, thus can get the peeling strengths corresponding to their uses. Specifically, if the weight concentration of the solid components decreased or the ratios of the weight of filler solid components/the weight of resin solid components increased, the numbers of pores will be increased, whereas, if the weight concentration of the solid components decreased or the temperature of solidification liquid increased, the diameter of pores can be increased. In the present invention, it is able to control the peeling strength by adjusting the pores. Herein, the term “peeling strength” generally means the force [N] applied during the peeling, and in particular, in this invention, it means the force applied when the cohesive failure layer is destroyed or broken. And it is able to control the strength by means of the degree of porous; that is to say, it is possible to decrease the peeling strength (facilitating the destruction of cohesive failure layer) by means of increasing the number of pores and enlarging the diameter of pores. The Re-sticking preventive label includes, for example, sheets sticking on the merchandise in stores, labels sticking on the wheel covers of bicycles, and sheets sticking on the automobile engines and so on, and it is necessary to adjust the peeling strength of the cohesive failure layer so as to be compatible to the adherend. In this invention, it is able to adjust the peeling strength by means of the porous degree, hence is able to produce sheets corresponding to the adhesive degree between the laminate and the adherend.

The resins of the above-mentioned coating fluid includes for example, polyester resin, polychlorovinyl resin, polystyrene resin, polymethyl methacrylate resin, polycarbonate resin, polyurethane resin, chlorovinyl-vinyl acetate copolymer resin, acrylic resin, acrylonitrile-styrene copolymer resin, acrylonitrile-methyl acrylate copolymer resin, polyvinylbutyral resin, styrene-butadiene copolymer resin, methyl methacrylate-butadiene copolymer resin, chlorovinyl-acrylic copolymer resin, vinyl acetate-acrylic copolymer resin, and mixture of cholorvinyl-acrylic copolymer resin or chorolovinyl-vinyl acetate copolymer resin and saturated copolyester resin.

There is no particular limitation for the fillers of the above-mentioned coating fluid, and they can be any organic filler and inorganic filler. Suitable choice can be, for example, polystyrene, polymethyl methacrylate, styrene-acrylic copolymer, synthesized silica, clay, talc, diatomite, calcium carbonate, calcined kaolin, titanium oxide, zinc oxide, satin white, etc. In which, calcium carbonate and titanium oxide are preferred. By means of the above-mentioned fillers, it is possible to enhance the printing performance and whiteness degree economically.

The organic solvent, which can be used in the above-mentioned coating fluid, can be any organic solvent as long as it can dissolve the resin, which forms the porous layer. The organic solvent includes, for example, dimethylformamide (DMF), N-methyl pyrrolidone, dimethyl sulfoxide, dimethyl acetamide, tetrahydrofuran, γ-butyrolactone etc. In which, from the view of processing performance of porous film, convenience and inexpensiveness, DMF is preferred.

The liquid as the non-solvent for the resin during the wet solidification processing includes water, ethanol, methanol etc. In which, water is preferred. That is because manipulation with water is very easy.

The density of thus formed cohesive failure layer 2 is in the range of 0.5˜1.0 g/cm³. Comparing with dry process, the cohesive failure layer 2 formed by wet solidification processing has a higher porous degree, and can form Re-sticking preventive laminate with suitable peeling strength. Hence, it is unnecessary to add a large amount of fillers, and it is also able to prevent the occurrence of paper powder. And, the density herein means the value based on JIS P8118.

Moreover, the weight concentration of solid components which forms cohesive failure layer 2 is preferably in the range of 5˜60 wt %, and more preferably in the range of 10˜50 wt %. In order to produce laminates with excellent peeling strength as Re-sticking preventive ones, it is necessary to set the concentration in the above range. If the concentration is lower than 5 wt %, the peeling strength will decrease, and it becomes difficult to be used for Re-sticking prevention. Whereas, if the concentration is higher than 60 wt %, contrarily, the peeling strength will increase, and it becomes difficult to destroy the cohesive failure layer, and it is sometime difficult to be used for Re-sticking prevention. In addition, if the concentration out of the above range, the coating performance (wetting characteristics to the substrate) deteriorates, surface turns to be uneven, and the product adaptability deteriorates, and thus it is not preferred.

Further, the weight ratio between fillers and resins of solid components of the coating fluid which forms the cohesive failure layer 2, is preferably in the range of 0.5˜6.0, and more preferably in the range of 2.0˜5.0 parts of fillers based on 1 part of resin. If the weight ratio is below 0.5, it becomes difficult to form pores, so that the peeling strength increased, and the cohesive failure of the cohesive failure layer becomes difficult. And if the ratio becomes higher than 6.0, fillers exposure on the surface, and cause the paper powder, thus is not preferred.

The cohesive failure layer 2 formed into porous structure by means of the above wet solidification process, and the porous structure is a structure with the arithmetic average roughness Ra of the peeling surface on the adhesive layer side of the cohesive failure layer which is destroyed by peeling is in the range of 0.4˜1.0 μm. The arithmetic average roughness Ra is related with content of the porous material, and by means of setting the Ra into the above range, the cohesive failure layer in the Re-sticking preventive laminate may have moderate pores. The term “arithmetic average roughness Ra” means the value get by the following steps: select standard length in the direction of average line from the roughness curve, sum the absolute value of deviation from the average line of the selected part to the measured curve, and average the value.

The adhesive which forms the adhesive layer 3, can use natural rubber, synthesized rubber, acrylic or urethane resin, in which, acrylic resin is preferred.

One embodiments of the Re-sticking preventive label with the above-mentioned constitute of this invention is applied by sticking the adhesive layer 3 on the adherend 4. And also, it can be applied by, such as, sticking the mold release paper on the adhesive layer 3 in advance and peeling off the mold release paper before use, or peeling label one by one from the mold release paper when stick with many labels.

As shown in FIG. 1, when a label sticking on the adherend 4 is peeled off, cohesive failure take place in the cohesive failure layer 2, and it is separated into the peeling surface 2a on the adhesive layer 3 side and the peeling surface 2b on the substrate 1 side. Thus, even if it is intend to peel off two labels expressing different prices and re-stick them, it will be impossible to re-stick nicely.

In this invention, in addition to the above structure, the following structure is also desired: when partly changed peeling strength processing is carried out on either side of cohesive failure layer 2, characters, signals or numbers are displayed on the above processed parts and unprocessed parts; and as one embodiment of which, the cases wherein the adhesive force between cohesive failure layer 2 and adhesive layer 3 decreased is explained by means of FIGS. 3˜5. Moreover, the signals same with FIG. 1 represent the same elements.

In FIG. 3, 5 represents the silicone coat layer provided on a part of the surface of cohesive failure layer 2 which are formed by coating on one side of substrate 1, and the adhesive force between the cohesive failure layer 2 and the adhesive layer 3 is decreased by means of this silicon coat layer, so that when the cohesive failure layer 2 is destroyed, no cohesive failure takes place in the parts with silicone coat layer 5, whereas in adhesive layer 3, the coat layer 5 is peeled off on the side of substrate 1. As results, characters, signals or numbers are displayed on the silicone coat processed or unprocessed parts of the cohesive failure layer. For instance, by means of processing the characters such as the words “opened” as shown in FIG. 5, other signals, numbers, or processing alone the profiles of these characters, thus allow the characters to be displayed when peeling them off.

Moreover, although not shown in the figures, the peeling strength changed processing may be the following: in the laminate in which a cohesive failure layer 2 is provided on one side of the substrate 1 and a printed surface of print layer is provided on the opposite surface, by means of applying alcohol solution of oil paints on the surface of the cohesive failure layer 2, for instance, by means of reversing displaying processing the characters such as “OPENED”, and forming adhesive layer 3 on it, thus makes the characters invisible from the printed surface by means of the invisibility of print layer; whereas, when the cohesive failure is take place by peeling, the processing displayed parts are not destroyed, and the substrate 1 is impregnated with ink, hence it is also able to display the characters of “OPENED” on substrate 1 side.

In addition, by means of the processing which tightening the porous parts of cohesive failure layer 2, the cohesive failure layer 2 may be partly destroyed, thus can display the characters. Specifically, by means of the processing with ink penetrating the cohesive failure layer 2 and/or coating fluid containing solvents (containing coating fluid), or by means of press processing such as extrusion or hot pressing, thus bury the pores of cohesive failure layer 2 and/or partly dissolve the resins, thus increase the density of the processed parts merely, and then forming adhesive layer 3 on the cohesive failure layer 2, when peeling off, the parts beyond the processed part within the cohesive failure layer 2 are carrying out the cohesive failure, and remaining on the adherend, whereas, because the adhesion between the substrate 1 and dense cohesive failure layer 2 and adhesive layer 3 turns better, no cohesive failure takes place, and remains on the adherend, hence the processed parts are displayed. Moreover, although the above-mentioned processing is a processing for cohesive failure layer 2 on the side of adhesive layer 3, the same will be done for the cohesive failure layer 2 on the side of substrate 1.

By means of adding thermal sensitizing agent, press sensitizing agent, infrared or ultraviolet laser chromogenic reagent, fluorescence chromogenic reagent etc, or coating the above fluorescence chromogenic reagent on the transparent substrate, after which, laminating the Re-sticking preventive laminate of the present invention, so as to be able to print pictures by various means.

The embodiments of the Re-sticking preventive laminate of the present invention are just like those mentioned above. In addition to labels, the laminate of the present invention can also be seals or sheets. For instance, by means of using as seals hiding private information, describing private information such as name or residence on postcards used for offer a reward, and laminating the laminate of the present invention on them, it is able to hide private information.

Moreover, in the Re-sticking preventive laminate of the present invention, because the parts remaining on the adherend after cohesive failure are writtalbe, it is possible to mark or sign on those parts. For instance, in the case that envelops were sealed with the Re-sticking preventive laminate of the present invention, the person who unsealed envelop by peeling the laminate off can identify who on earth have unsealed envelop by making signatures in the parts remaining on envelop.

Furthermore, it is also allowed to use the Re-sticking preventive laminate of the present invention by rolling it into a roller, just like tapes.

### EXAMPLES

Hereinafter, the examples in which the Re-sticking preventive laminates of the present invention are used for labels will be explained. The term “part(s)” represent the components in the composition means part(s) by weight.

### Example 1

The coating fluid with the following composition-1 is coated by applicator on the surface of biaxial oriented polyester film (Melinex 545, Teijin DuPont film Ltd., thickness: 50 μm), dip it into water of 20° C. for 1 minute, and further dip it into hot water of 90° C. for 5 seconds, then remove the water, coat the antistatic agent, dry at 80° C., thus form a coating layer with a thickness of 20 μm. Then, provide adhesive (acrylic resin) on the coating layer, thus produce the Re-sticking preventive label.

[Composition-1]

| | |
|---|---|
| acrylonitrile -styrene copolymer resin (LITAC120 PCF, | 7 parts |
| NIPPON A & L INC., solid components 100%) | |
| light calcium carbonate (light calcium carbonate, | 27 parts |
| MARUO Calcium Co., Ltd. solid components 100%) | |
| titanium oxide (TIPAQUE R-820, ISHIHARA. SANGYO | 3 parts |
| KAISHA. LTD., solid components 100%) | |
| dimethylformamide (solid components 0%) | 60 parts |
| plasticizer (dioctyl adipate, solid components 100%) | 3 parts |

### Example 2

The coating fluid with the following composition-2 is coated by bar coater on the surface of biaxial oriented polypropylene film (Sun Orient PB-260, Futamura. co. jp. thickness: 50 μm). After set the anchor layer and then, the coating fluid with the following composition-3 is coated by applicator. Then dip it into water of 20° C. for 1 minute, and further dip it into hot water of 90° C. for 5 seconds, then remove the water, coat the antistatic agent, dry at 80° C., thus form a coating layer with a thickness of 20 μm. Then, provide adhesive (acrylic resin) on the coating layer, thus produce the Re-sticking preventive label.

[Composition-2]

| | |
|---|---|
| water (solid components 0%) | 59 parts |
| styrene-acrylic resin emulsion (Acronal YJ2721Dap, | 37 parts |
| Shinyo Chemical Ltd., solid components 46.5%) | |
| silica (MIZUKASIL P-801 MIZUSAWA CHEM CO., | 2 parts |
| solid components 100%) | |
| wetting agent (SN Wet 366, San Nopco Ltd., | 1 part |
| solid components 70%) | |
| thickener (Primal RM8W, Rohm And Hass Japan Ltd., | 1 part |
| solid components 30%) | |

[Composition-3]

| | |
|---|---|
| acrylonitrile -styrene copolymer resin (LITAC120 PCF, | 8 parts |
| NIPPON A & L INC., solid components 100%) | |
| light calcium carbonate (light calcium carbonate, MARUO | 18 parts |
| Calcium Co., Ltd. solid components 100%) | |
| titanium oxide (TIPAQUE R-820, ISHIHARA. SANGYO | 2 parts |
| KAISHA. LTD., solid components 100%) | |
| dimethylformamide (solid components 0%) | 69 parts |
| plasticizer (dioctyl adipate, solid components 100%) | 3 parts |

### Example 3˜Example 16

Example 1˜2 is depicted above, whereas, in Example 3˜16, the same substrate 1 as Example 1 is used, and cohesive failure layer is formed by the same wet solidification process as Example 1, and adhesive layer is formed on the surface of the cohesive failure layer with acrylic resin in the same way as Example 1. The difference from Example 1 lies in the different composition of the coating fluid forming the cohesive failure layer, the compositions of the coating fluid forming the cohesive failure layer in examples 3˜16 corresponding to the composition-1 of Example 1 is showed in the table 1 below. In addition, table 1 also shows the composition-1 of Example 1 and the composition-3 of Example 2. And the “part(s)” of different components in table 1 represents part(s) by weight.

TABLE 1

| | | | | | | | | | | | | Ex | Ex | Ex | Ex | Ex | Ex | Ex |
|---|---|---|---|---|---|---|---|---|---|---|---|---|---|---|---|---|---|---|
| Example | | unit | Ex 1 | Ex 2 | Ex 3 | Ex 4 | Ex 5 | Ex 6 | Ex 7 | Ex 8 | Ex 9 | 10 | 11 | 12 | 13 | 14 | 15 | 16 |
| Coating liquid | acrylonitrile-styrene | Part(s) | 7 | 8 | 4 | 3 | 13 | 7 | 4 | 24 | 13 | 8 | 7 | 5 | 4 | 11 | 9 | 15 |
| composition | copolymer resin (solid | | | | | | | | | | | | | | | | | |
| | components 100%) | | | | | | | | | | | | | | | | | |
| | light calcium carbonate | Part(s) | 27 | 18 | 3 | 4 | 1 | 6 | 9 | 2 | 12 | 17 | 25 | 26 | 27 | 40 | 43 | 52 |
| | (solid components 100%) | | | | | | | | | | | | | | | | | |
| | titanium oxide (solid | Part(s) | 3 | 2 | 0 | 1 | 0 | 1 | 1 | 0 | 1 | 2 | 3 | 3 | 3 | 5 | 5 | 6 |
| | components 100%) | | | | | | | | | | | | | | | | | |
| | dimethylformamide | Part(s) | 60 | 69 | 91 | 91 | 81 | 83 | 84 | 64 | 69 | 70 | 62 | 64 | 64 | 39 | 39 | 21 |
| | (solid components 0%) | | | | | | | | | | | | | | | | | |
| | dioctyl adipate (solid | Part(s) | 3 | 3 | 2 | 1 | 5 | 3 | 2 | 10 | 5 | 3 | 3 | 2 | 2 | 5 | 4 | 6 |
| | components 100%) | | | | | | | | | | | | | | | | | |

Hereinafter, comparable examples will be explained. In which, the term “part(s)” represents the components in the composition means part(s) by weight.

### Comparative Example 1

The coating fluid with the following composition-4 is coated by gravure coater on the surface of biaxial oriented polyester film (Melinex 545, Teijin DuPont film Ltd., thickness: 50 μm), dry at 80° C., and then, the coating fluid with the following composition-5 is coated on this surface by gravure coater, dry at 100° C., thus form a coating layer with a thickness of 10 μm. Then, provide adhesive (acrylic resin) on the coating layer, thus produce the Re-sticking preventive label.

[compostion-4]

| | |
|---|---|
| ethyl acetate (solid component 0%) | 21 parts |
| toluene (solid component 0%) | 29 parts |
| methyl ethyl ketone (solid component 0%) | 20 parts |
| titanium oxide (TIPAQUE R-670, ISHIHARA. | 14 parts |
| SANGYO KAISHA. LTD., solid components 100%) | |
| saturated copolyester resin (Byron 300, TOYOBO Ltd., | 16 parts |
| solid components 100%) | |

[compostion-5]

| | |
|---|---|
| isopropylene alcohol (solid component 0%) | 2 parts |
| cyclohexane (solid component 0%) | 19 parts |
| toluene (solid component 0%) | 62 parts |
| methyl ethyl ketone (solid component 0%) | 2 parts |
| titanium oxide (TIPAQUE R-670, ISHIHARA. SANGYO | 11 parts |
| KAISHA. LTD., solid components 100%) | |
| saturated copolyester resin (Byron 300, TOYOBO | 4 parts |
| Ltd., solid components 100%) | |

### Comparative Example 2˜4

The coating fluid with the composition-4 is coated by gravure coater with the same method of comparative example 1 on the surface of the same substrate of comparative example 1, dry at 80° C., and then, the coating fluid with a composition of the following table 2 corresponding to the composition-5 is coated on this surface by gravure coater, then dry at 100° C., thus form a coating layer with a thickness of 10 μm. Then, provide adhesive (acrylic resin) on the coating layer, thus produce the Re-sticking preventive label of comparative example 2˜4. Table 2 also represents the composition-5 of comparative example 1. All the components in table 2 are expressed by weight part(s) “part(s)”.

TABLE 2

| | | | Com. | Com. | Com. | Com. |
|---|---|---|---|---|---|---|
| Comparative Example | | unit | Ex 1 | Ex 2 | Ex 3 | Ex 4 |
| Coating | isopropylene alcohol (solid component | Part(s) | 2 | 2 | 2 | 1 |
| liquid | 0%) | | | | | |
| composition | cyclohexane (solid component 0%) | Part(s) | 19 | 16 | 16 | 9 |
| | toluene (solid component 0%) | Part(s) | 62 | 52 | 52 | 29 |
| | methyl ethyl ketone (solid component 0%) | Part(s) | 2 | 2 | 2 | 1 |
| | titanium oxide (solid components 100%) | Part(s) | 11 | 20 | 24 | 43 |
| | saturated copolyester resin (solid | Part(s) | 4 | 8 | 4 | 17 |
| | components 100%) | | | | | |

[Evaluation Method]

The peeling strength is evaluated by adhesion test (according to JIS Z-0237). Adhesive label is applied on the SUS 304 steel board by manual type tape pressing roller, then determine the strength by tensile machine (Strograph V1-C, produced by Toyoseiki Ltd.).

The arithmetic average roughness Ra is determined by testing the adhesive layer side of cohesive failure layer which is destroyed by peeling. The arithmetic average roughness is determined by laser displacement gauge (produced by KEYENCE LTD.) according to JIS B0601-1994.

The tape peeling state is evaluated by chessboard tape method (according to JIS-5400-1990). Cut it by penetrating the cohesive failure layer until arriving to the substrate surface to form marks in form of chessboard, and apply cellophane tape (produced by Nichiban, No.405, width 18 mm) on these chessboard by manual type tape pressing roller. Peel the cellophane tape along an angle of 45° at the speed of 20 mm/sec, and evaluate from the areas of the defect part which is the areas of the square areas sticking on the cellophane tape of cohesive failure layer (the cohesive failure layer which sticking on the tape or the cohesive failure parts of the substrate surface). “◯” represents the area of defect parts is more than 50%, “Δ” represents the area of defect parts is 50% or less, and “×” represents no defect part was found.

The density is determined according to JIS P8118.

The evaluation results of example 1˜16 are show in table 3 below, and the evaluation results of comparative example 1˜4 are show in table 4 below.

TABLE 3

| Example | | | | | | | | | | | | | | | | | |
|---|---|---|---|---|---|---|---|---|---|---|---|---|---|---|---|---|---|
| (evaluation) | unit | Ex 1 | Ex 2 | Ex 3 | Ex 4 | Ex 5 | Ex 6 | Ex 7 | Ex 8 | Ex 9 | Ex 10 | Ex 11 | Ex 12 | Ex 13 | Ex 14 | Ex 15 | Ex. 16 |
| Density | g/cm³ | 0.9 | 0.9 | 0.5 | 0.5 | 0.8 | 0.7 | 0.6 | 0.9 | 0.8 | 0.7 | 0.9 | 0.9 | 1 | 0.9 | 1 | 1 |
| Arithmetic | μm | 0.72 | 0.63 | 0.8 | 0.7 | 0.8 | 0.8 | 0.8 | 0.7 | 0.7 | 0.7 | 0.6 | 0.6 | 0.6 | 0.5 | 0.5 | 0.7 |
| average | | | | | | | | | | | | | | | | | |
| roughness | | | | | | | | | | | | | | | | | |
| Coating fluid | % | 40 | 31 | 9 | 9 | 19 | 17 | 16 | 36 | 31 | 30 | 38 | 36 | 36 | 61 | 61 | 79 |
| solid | | | | | | | | | | | | | | | | | |
| components | | | | | | | | | | | | | | | | | |
| Weight ratio of | — | 4.3 | 2.5 | 0.8 | 1.7 | 0.1 | 1.0 | 2.5 | 0.1 | 1.0 | 2.4 | 4.0 | 5.8 | 7.5 | 4.1 | 5.3 | 3.9 |
| filler solid | | | | | | | | | | | | | | | | | |
| component/resin | | | | | | | | | | | | | | | | | |
| solid component | | | | | | | | | | | | | | | | | |
| Peeling strength | N/25 mm | 0.416 | 0.14 | 0.1 | 0.1 | 0.6 | 0.4 | 0.1 | 0.6 | 0.6 | 0.2 | 0.4 | 0.3 | 0.2 | 1 | 0.8 | 1.2 |
| Tape peeling state | — | ◯ | ◯ | ◯ | ◯ | ◯ | ◯ | ◯ | ◯ | ◯ | ◯ | ◯ | ◯ | ◯ | Δ | ◯ | Δ |

TABLE 4

| Comparative | | Com. | Com. | Com. | Com. |
|---|---|---|---|---|---|
| Example (evaluation) | unit | Ex 1 | Ex 2 | Ex 3 | Ex 4 |
| Density | g/cm³ | 1.7 | 1.5 | 3.2 | 1.6 |
| Arithmetic average roughness | μm | 0.8 | 0.8 | 0.2 | 0.3 |
| Coating fluid solid components | % | 15 | 28 | 28 | 60 |
| Weight ratio of filler solid | — | 2.8 | 2.5 | 6.0 | 2.5 |
| component/resin solid | | | | | |
| component | | | | | |
| Peeling strength | N/25 mm | 5 | 6.5 | 4.5 | 10 |
| Tape peeling state | — | X | X | Δ | X |

[Evaluation]

From the results shown above, the laminates formed with cohesive failure layers by wet solidification process may have various values of peeling strength, thus may form excellent tape peeling state. Moreover, on condition that the solid components concentrations fall within 5˜60 wt %, and the solid components ratios between fillers and resins fall within 0.5˜6, the tape peeling state may be better, and it is also able to carry the surface coating excellently.

### INDUSTRIAL APPLICABILITY

The present invention is able to provide Re-sticking preventive laminates with corresponding strengths case by case, such as laminates which are allowed to be peeled off stealthily and quickly just like the labels of the merchandises in super-markets, laminates which are allowed to be peeled off leisurely just like the labels of brand products or genuine products. Because the present invention is cohesive destroyed by means of the pores of cohesive failure layer, and these pores are formed by wet solidification process, foaming agents are not necessary, and there remains no inconvenience along with lasers etc. Moreover, only resins and fillers are required, thus it is able to produce the laminates economically. Further, by means of providing coating layer on the surface of substrate opposite to the side provided with cohesive failure layer, it is able to form laminates with printing adaptability.

### DRAWINGS

FIG. 1 shows the cross-section view of one embodiment of the Re-sticking laminate of the present invention suitable for labels.

FIG. 2 is the enlarged plane figure of the peeling surface on the adhesive layer side after the label of FIG. 1 was peeled.

FIG. 3 shows the cross-section view of another embodiment of the Re-sticking laminate of the present invention suitable for labels.

FIG. 4 shows the cross-section view showing the procedure of peeling the label of FIG. 3.

FIG. 5 shows the plane view on the adhesive layer side displaying with characters when the label of FIG. 3 was peeled.

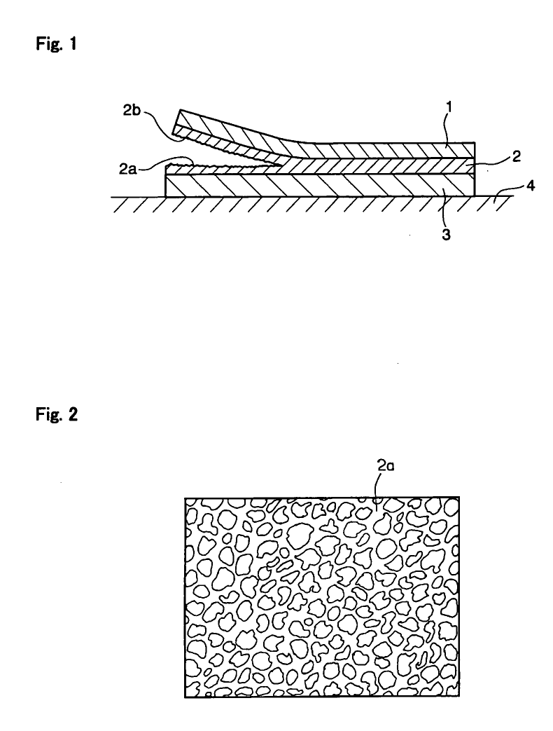

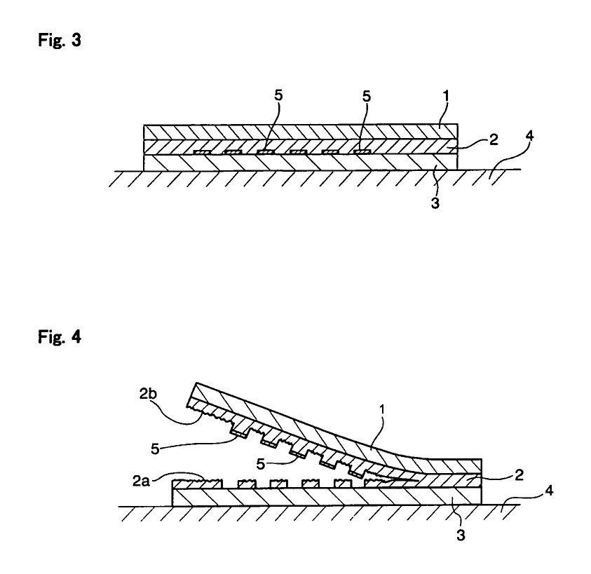

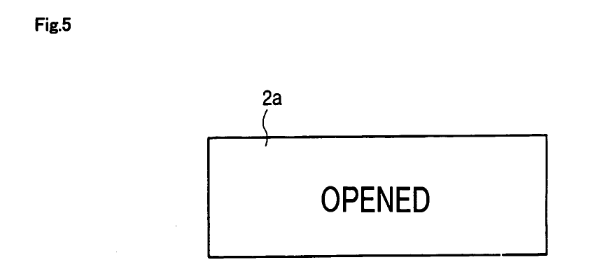

Signals

| | |
|---|---|
| 1 | substrate |
| 2 | cohesive failure layer |
| 3 | adhesive layer |
| 4 | adherend |
| 5 | silicone coat layer |

What is claimed is:

1. A Re-sticking preventive laminate, wherein a cohesive failure layer is provided on at least one side of the substrate by means of coating, and an adhesive layer is provided on the surface of the cohesive failure layer, characterized in that:
the cohesive failure layer has a porous structure provided by wet solidification process.

2. The Re-sticking preventive laminate according to claim 1, characterized in that:
the density of the cohesive failure layer according to JIS P8118 is in the range of 0.5˜1.0 g/cm³.

3. The Re-sticking preventive laminate according to claim 1, characterized in that:
the arithmetic average roughness Ra of the peeling surface on the adhesive layer side of the cohesive failure layer which is destroyed by peeling is in the range of 0.4˜1.0 μm.

4. The Re-sticking preventive laminate according to claim 2, characterized in that:
the arithmetic average roughness Ra of the peeling surface on the adhesive layer side of the cohesive failure layer which is destroyed by peeling is in the range of 0.4˜1.0 μm.

5. The Re-sticking preventive laminate according to any one of the claims 1˜4, characterized in that:
the cohesive failure layer contains resins and fillers.

6. A Re-sticking preventive laminate, wherein a cohesive failure layer is provided on at least one side of the substrate by means of coating, and an adhesive layer is provided on the surface of the cohesive failure layer, characterized in that:
the cohesive failure layer has a porous structure provided by wet solidification process, and, the numbers and sizes of pore of the cohesive failure layer is adjustable by means of adjusting the weight concentration of the solid components forming the cohesive failure layer and/or the weight ratios between the fillers and resins in the solid components in the coating fluid.

7. The Re-sticking preventive laminate according to claim 6, characterized in that:
the weight concentration of the solid components of the coating fluid which forms the cohesive failure layer is adjusted into the range of 5˜60 wt %.

8. The Re-sticking preventive laminate according to claim 6, characterized in that:
the weight ratios between fillers and resins of solid components of the coating fluid which forms the cohesive failure layer is adjusted into the range of 0.5˜6.0.

9. The Re-sticking preventive laminate according to claim 7, characterized in that:
the weight ratios between fillers and resins of solid components of the coating fluid which forms the cohesive failure layer is adjusted into the range of 0.5˜6.0.

10. The Re-sticking preventive laminate according to any one of the claims 6˜9, characterized in that:
the density of the cohesive failure layer according to JIS P8118 is in the range of 0.5˜1.0 g/cm³.

11. The Re-sticking preventive laminate according to any one of the claims 6˜9, characterized in that:
the cohesive failure layer contains resins and fillers.

12. A Re-sticking preventive laminate, wherein a cohesive failure layer is provided on at least one side of the substrate by means of coating, and an adhesive layer is provided on the surface of the cohesive failure layer, characterized in that:
the cohesive failure layer has a porous structure provided by wet solidification process, and, when a processing with partly changed peeling strength is carried out on any side of the above cohesive failure layer, and the above-mentioned cohesive failure layer is cohesive destroyed, it is able to display the above processed parts or un-processed parts with character, signal or number and the like forms.

13. The Re-sticking preventive laminate according to claim 12, characterized in that:
the said process is a process increasing or decreasing the adhesive strength between the cohesive failure layer and the layer contact with it.

14. The Re-sticking preventive laminate according to claim 12, characterized in that:
the said process is a process injecting ink into the pores of the cohesive failure layer by printing or the like.

15. The Re-sticking preventive laminate according to claim 12, characterized in that:
the said process is a solvent coating process dissolving the resin of the cohesive failure by coating solvents.

16. The Re-sticking preventive laminate according to claim 9, characterized in that:
the said process is a pressing process changing the thickness of the cohesive failure layer by extruding or hot-pressing.

17. The Re-sticking preventive laminate according to any one of the claims 12˜16, characterized in that:
the density of the cohesive failure layer according to JIS P8118 is in the range of 0.5˜1.0 g/cm³.

18. The Re-sticking preventive laminate according to any one of the claims 12˜16, characterized in that:
the cohesive failure layer contains resins and fillers.
